(19) United States
(12) Patent Application Publication
(10) Pub. No.: US 2016/0381056 A1
(43) Pub. Date: Dec. 29, 2016

(54) SYSTEMS AND METHODS FOR CATEGORIZATION OF WEB ASSETS

(71) Applicant: Veracode, Inc., Burlington, MA (US)

(72) Inventor: Michael Floering, Jamaica Plain, MA (US)

(21) Appl. No.: 14/747,280

(22) Filed: Jun. 23, 2015

(51) Int. Cl. H04L 29/06; G06F 17/30

(52) U.S. Cl. CPC H04L 63/1425; G06F 17/30345; G06F 17/30598; G06F 17/30867; G06F 17/30424; H04L 63/1416; H04L 63/1483

(57) ABSTRACT

In a system for determining the state of an asset owned by an entity, a number of scores that are representative of the state of the asset are queried and received. The received scores are analyzed and aggregated to determine whether the asset is in a state of disrepair.

### FIELD OF THE INVENTION

This disclosure generally relates to categorization of web assets and, more particularly, to systems and methods for identifying those web assets of an entity that are likely in a state of disrepair, potentially creating a liability for the entity.

### BACKGROUND OF THE INVENTION

A web property, in general, can be a web host, a web server, or a web service. One or more web hosts can be associated with a domain (typically, an Internet domain) or subdomain. Similarly, one or more web servers and/or one or more web services can also be associated with a domain (e.g., XYZ.com, LMN.org, etc.), or a subdomain (e.g., www.XYZ.com, etc.). A web property can be owned directly or indirectly by an entity. Usually, the owner entity can be liable for any problems associated with a web property, e.g., malicious attacks against a web property such as data breach at a web server. Examples of problems also include, but are not limited to, down time of a web service greater than a specified limit, use of a web host in launching malicious attacks (e.g., spreading of malware, computer viruses, etc.).

Direct ownership generally occurs when the entity develops or contracts a third party to develop a web property and/or provides or contracts a third party to provide one or more services using the web property. As such, under direct ownership, the owner entity can typically enforce procedures to minimize any problems occurring with a web property for which the owner entity may be liable. Problems of which the owner entity is not aware may nevertheless exit in association with some directly owned web properties.

Indirect ownership can occur when an entity may not actively develop and/or manage a web property and may not actively control such development/management, but may acquire rights to the web property through business/legal transactions such as mergers, acquisitions, etc. As such, an indirect owner often does not know the contents, attributes, implementation details, security details, or other characteristics of the indirectly owned web property, so as to implement procedures that can minimize the occurrence of problems with that web property. In some instances, an indirect owner may not even know the existence of some of the owned web properties. Nevertheless, an indirect owner entity may be responsible or liable for any problems associated with any indirectly owned web property, including the consequences of any failures of the web property and the consequences of attacks against the web property.

### SUMMARY OF THE INVENTION

Various embodiments of the present invention can facilitate detection of web properties/assets owned by an entity that are likely in a state of disrepair. This can be achieved, at least in part, by obtaining one or more quality scores for an asset. These quality stores can indicate trustworthiness and/or reputation of the asset, presence of any malware or other harmful content thereon, whether the asset is child safe, whether the asset was used in phishing attacks or was the target of a phishing attack, etc. These scores are aggregated, and the aggregated score is used to determine whether the evaluated asset is in a state of disrepair. The owner entity may take appropriate remedial action for the assets in a state of disrepair. In some instances, web properties likely owned by the entity may be detected, and a list of assets (domains and subdomains) for which the entity can be liable is generated. For one or more of these assets, a determination of whether the assets is in a state of disrepair may then be made, and appropriate remedial actions may be taken.

Accordingly, in one aspect, a method is provided for determining whether an asset of an entity is affected. The method includes performing by a processor the steps of: querying from one or more quality-assessment services, respective quality scores for an asset, and aggregating the one or more quality scores to obtain an aggregate score for the asset. The method also includes determining whether the asset is affected based on, at least in part, the aggregate score for the asset. An identifier of the asset may include a domain name or a subdomain name.

Querying a quality score from a quality-assessment service may include transmitting through a network an asset identifier to a server providing the quality-assessment service. The one or more quality-assessment services may include a WOT service. A respective quality score received from the WOT service may include one or more of: (i) a reputation score, (ii) a child safety rating score, and (iii) a category score corresponding to a specified category. The specified category can be BAD, ADULT, or a WOT-defined category.

In some embodiments, the one or more quality-assessment services includes a GSB service, and a respective quality score received from the GSB service may represent at least one of: (i) a likelihood of presence of malware at the asset, and (ii) a likelihood that the asset comprises a phishing offender. Alternatively or in addition, the one or more quality-assessment services may include a phishing repository report service, and a respective quality score received from the phishing repository report service may represent one or more of: (i) a likelihood that the asset comprises a phishing offender, and (ii) a likelihood that the asset was a target of a phishing attack. In some embodiments, the one or more quality-assessment services include a domain registry risk assessment service, and a respective quality score received from the domain registry risk assessment service may represent a similarity between an identifier of the asset, i.e., the domain/subdomain name and a domain name.

Aggregating the one or more quality scores may include (i) designating a Boolean value to each quality score based on a respective threshold and (ii) computing a logical OR of the respective Boolean values, and determining whether the asset is affected may include designating the asset as affected if the logical OR is TRUE. Aggregating the one or more quality scores may also include computing a weighted average of the one or more quality scores based on respective scaling factors. Determining whether the asset is affected may include designating the asset as affected if the weighted average is at least equal to a specified threshold.

In some embodiments, the method further includes receiving, in memory, a list of resources, and scanning, using a scanner, each resource in the list, to obtain a list of assets associated with an entity. The method may further include repeating the querying, aggregating, and designating steps for each asset in the list of assets, to identify any affected assets associated with the entity. A resource in the list of resources can be a domain name, an Internet protocol (IP) address, or a CIDR block. The scanning may include port scanning, idle scanning, domain name service (DNS) lookup, subdomain brute-forcing, or a combination of two or more of these techniques. The method may also include performing vulnerability analysis for one or more assets in the list of assets that are not designated as affected assets.

In another aspect, a computer system for determining whether an asset of an entity is affected includes a first processor and a first memory coupled to the first processor. The first memory includes instructions which, when executed by a processing unit that includes the first processor and/or a second processor, program the processing unit, that is in electronic communication with a memory module that includes the first memory and/or a second memory to query from one or more quality-assessment services, respective quality scores for an asset. The processing unit is also programmed to aggregate the one or more quality scores to obtain an aggregate score for the asset, and to determine whether the asset is affected, based on, at least in part, the aggregate score for the asset. In various embodiments, the instructions can program the processing unit to perform one or more of the method steps described above.

In another aspect, an article of manufacture that includes a non-transitory storage medium has stored therein instructions which, when executed by a processing unit in electronic communication with a memory module, program the processing unit, for determining whether an asset of an entity is affected, to, query from one or more quality-assessment services, respective quality scores for an asset. The processor is also programmed to aggregate the one or more quality scores to obtain an aggregate score for the asset, and to determine whether the asset is affected, based on, at least in part, the aggregate score for the asset. In various embodiments, the stored instructions can program the processor to perform one or more of the method steps described above.

### BRIEF DESCRIPTION OF THE DRAWINGS

Various embodiments of the present invention taught herein are illustrated by way of example, and not by way of limitation, in the figures of the accompanying drawings, in which:

FIG. 1 illustrates one example of a process of obtaining one or more scores for an asset, according to one embodiment;

FIG. 2 illustrates one example of a process of aggregating scores associated with an asset, according to one embodiment; and

FIG. 3 schematically depicts a system for identifying web properties and assets likely owned by an entity, according to one embodiment.

### DETAILED DESCRIPTION OF THE INVENTION

In general, one or more quality scores are obtained for a particular asset, e.g., a domain or subdomain such as XYZ.com, www.XYZ.com, w3.PQR.org, etc., from one or more services. To this end, one or more queries are sent to one or more services using, for example, application program interfaces (APIs) provided by the respective services. Each query includes the domain name or sub-domain name associated with the asset to be evaluated, and may include one or more types of scores requested. Examples of the types of scores include trustworthiness or reputation, child safety, representing whether the asset is rated as safe for children, presence of malware, etc. Typically, a query is sent to a service/service provider through a network (e.g., the Internet). In response, one or more types of requested scores and/or one or more types of ratings are received, e.g., through a network, from the corresponding service/service provider. Respective confidence levels corresponding to one or more scores/ratings may also be received from the services. In some embodiments, several queries are sent to a particular service, each one requesting one or more particular type(s) of score(s).

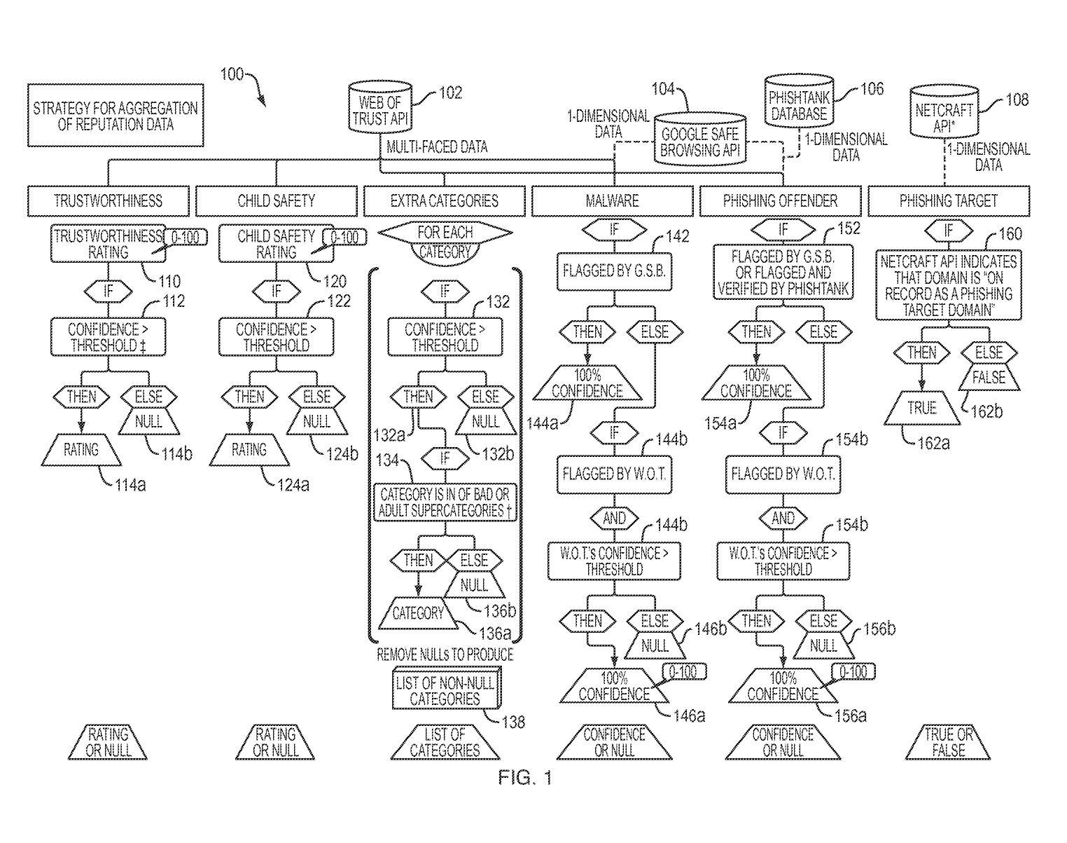

For example, with respect to FIG. 1, in a process 100, a trustworthiness rating and a corresponding confidence level for a specified asset are received from a trustworthiness/reputation service 102 (e.g., Web of Trust (WOT) service), in step 110. If the confidence level is determined in step 112 to be greater than or at least equal to a specified confidence threshold, the trustworthiness rating is marked and/or stored in step 114a, for further processing. Otherwise, the trustworthiness rating is set to be zero or NULL in step 114b. A child safety rating and a corresponding confidence level for the asset may be received from the same service 102 in step 120. If it is determined in step 122 that the associated confidence level is greater than or is at least equal to a specified confidence threshold, which can be the same threshold used in the step 112 or it can be a different threshold, the child safety rating is marked and/or stored in step 124a, for further processing. Otherwise, the child safety rating is set to be zero or NULL in step 124b.

Some trustworthiness/reputation services such as the WOT service define a number of service-provider-specific categories, some of which may be classified as “BAD” or “ADULT” super-categories. The trustworthiness/reputation service 102 may classify the domain or subdomain name associated with the asset as belonging to one or more categories. The query may request whether the transmitted domain/subdomain name is included in any of these categories and/or super-categories and, in response, the service 102 can indicated any such inclusions together with the respective confidence levels for the inclusions. For each category supplied by a provider of the service 102, the associated confidence level, if received from the service, is compared with a respective use-specified threshold in step 132. If in step 132a the associated confidence level is determined to be greater than or at least equal to the respective specified threshold, it is determined in step 134 whether that category is included in a super-category designated as an ill-reputed super-category (e.g., BAD, ADULT, etc.). If the category is part of an ill-reputed super category, that category is recorded/stored in step 136a, for further analysis. If the confidence level for a category is less than the specified respective threshold, the category is marked NULL in step 132b. If the category is not included in an ill-reputed super-category, then also the category is marked NULL in step 136b. A list of categories that are not marked NULL is recorded/stored in step 138. That list includes the categories to which the specified domain/subdomain name belongs with certain confidence, as determined by the trustworthiness/reputation service 102. Moreover, some of the categories in the list may also be included in an ill-reputed super-category.

A particular type of score may be requested from two or more different services/service providers. For example, a malware score, indicating whether malware was detected at the web asset, may be requested from the trustworthiness/reputation service 102 and, in addition, from a safe browsing/harmful-content-detection service 104 (e.g., Google Safe Browsing™ (GSB) service). The malware score received from the trustworthiness/reputation service 102 such as WOT can be based on feedback, reports, complaints, etc. from users (e.g. the Internet users at large), and may thus represent user perception and/or reputation of the asset. The malware score received from the service 104 (such as GSB), can be based on actual testing of the specified asset, typically performed prior to receiving the query. In step 142, it is tested whether the presence of malware at the asset corresponding to the queried domain/subdomain name is indicated by the safe browsing/harmful-content-detection service 104 (e.g., GSB). If the service 104 does indicate malware presence, a confidence level indicating malware presence at the asset is set to a maximum value, i.e., 100%, in step 144a. Otherwise, it is tested in step 144b whether malware presence is indicated by the trustworthiness/reputation service 102 at a confidence level greater than or equal to a corresponding specified confidence level. If so, in step 146a, the confidence level indicating malware presence at the asset is set to the confidence level received from the service 102. Otherwise, the confidence level is set to a NULL value in step 146b.

A phishing offender score, indicating whether the web asset was involved in phishing attacks on other websites, web servers, web services, etc., may be requested from the trustworthiness/reputation service 102, from the safe browsing/harmful-content-detection service 104 (e.g., GSB), and in addition, from a phishing attacks repository 106 (e.g., PhishTank™). In step 152, it is tested whether the safe browsing/harmful-content-detection service 104 or the phishing attacks repository 106 identify the domain/subdomain associated with the asset as a phishing attacker and, if the asset is so identified, a confidence level indicating that the asset is likely a phishing attacker is set to maximum value, i.e., 100%, in step 154a. Otherwise, it is tested whether the trustworthiness/reputation service 102 identifies the asset as a phishing attacker, at a confidence level at least equal to a corresponding specified confidence level, in step 154b. If the asset is so identified, the confidence level indicating that the asset is likely a phishing offender is set to the confidence level received from the service 102, at step 156a. Otherwise, the confidence level is set to a NULL value in step 156b.

From a domain name registry service 108, a score indicative of similarity between the domain/subdomain name associated with the asset under evaluation and other domain/subdomain names may be received. The similarity may be measured in terms of a lexicographical difference between the domain/subdomain name corresponding to the asset and one or more other domain/subdomain names. If other domains/subdomains having names very similar to the name of the domain/subdomain associated with the asset (e.g., having up to only one or two different characters, etc.), are known or are found, it is likely that the asset was the target of a phishing attack. The domain name registry service 108 (e.g., NatCraft™) may store actual information about known/reported phishing attacks and, as such, a phishing target score obtained from the service 108 may indicate whether the asset was actually subjected to a phishing attack. After testing in step 160 for any such indication received from the domain name registry service 108, a phishing target flag may be set to TRUE, if the indication is positive, or to FALSE otherwise, in steps 162a, 162b, respectively.

It should be understood that FIG. 1 is illustrative and that in general different or additional trustworthiness/reputation services, harmful content detection services, safe browsing services, malware/virus detection/scanning services, domain name related services, etc., can be queried to obtain different types of scores. In various embodiments, as few as one and as many as 5, 8, 15 different scores including different types of scores from the same or different services and/or the same type of score from different services may be obtained.

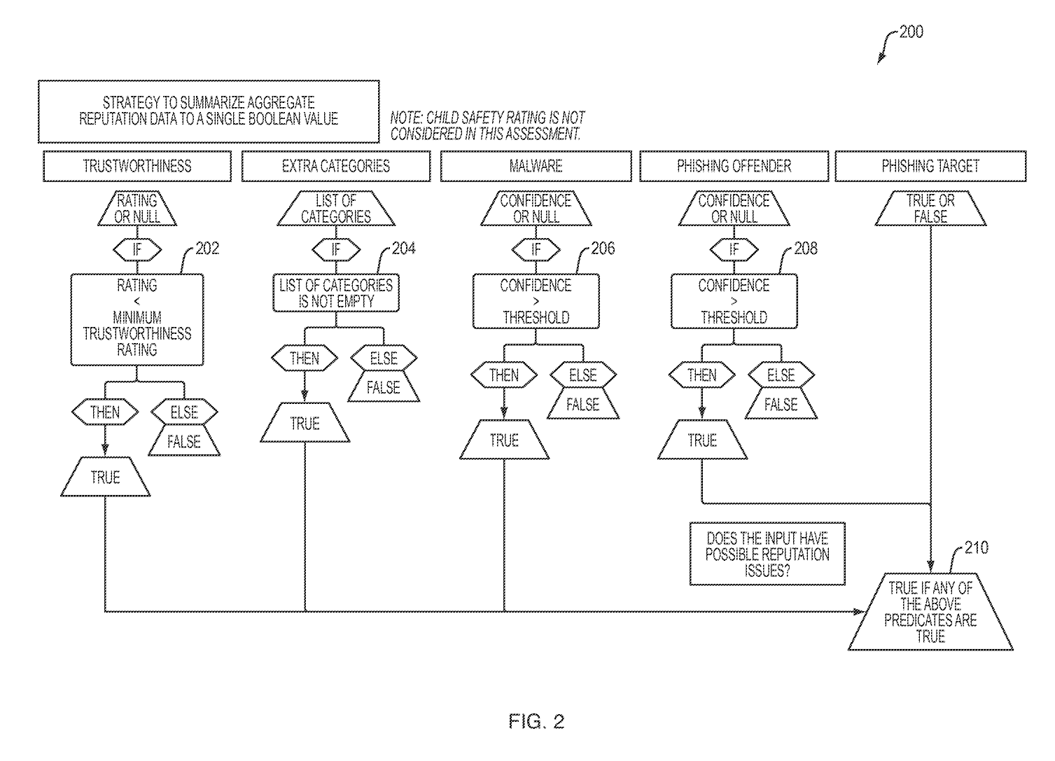

With reference to FIG. 2, one or more of the obtained/computed scores (as described with reference to FIG. 1) are aggregated to determine whether the asset under test is in a state of disrepair. In step 202, the trustworthiness rating is compared to a minimum trustworthiness rating that may be specified by a user, and a trustworthiness flag is set to TRUE or FALSE values depending on whether the obtained/computed rating is less than or at least equal to the specified minimum rating. In step 204, it is tested whether the list of trustworthiness/reputation service categories associated with the asset is empty. That list is generated as described above with reference to FIG. 1, and may indicate whether a trustworthiness/reputation service has categorized the asset as likely harmful. Therefore, if the list is not empty, the asset is likely harmful and, as such, a harmful category flag is set to a TRUE value. If the list is empty, the harmful category flag is set to a FALSE value.

In step 206, the confidence level indicating presence of malware at the asset is compared to a corresponding threshold that may be specified by a user, and a malware presence flag is set to TRUE or FALSE values depending on whether the obtained/computed confidence level for malware presence indication is at least equal to or is greater than the specified threshold. Similarly, in step 208, the confidence level indicating whether the asset is or was a phishing offender is compared to a corresponding user-specified threshold, and a phishing offender flag is set to TRUE or FALSE values depending on whether the obtained/computed confidence level indicating that the asset is/was a phishing offender is at least equal to or is greater than the user-specified threshold.

If any one of these flags and the phishing target flag (set as described above with reference to FIG. 1) is TRUE, a summary flag is set to TRUE in step 210. Otherwise, i.e., if all of the flags are FALSE, the summary flag is set to FALSE in the step 210. A TRUE value for the summary flag generally indicates that the evaluated asset is in a state of disrepair.

In some embodiments, the various scores may be aggregated in other ways. For example, the different scores may be normalized to a uniform scale e.g., a numeral scale such as 1-100, 1-20, etc., or a letter scale such as “A-F,” etc. The normalized or un-normalized scores may be scaled and added/combined to obtain a final score. The scaling factors can indicate relative importance of different types of scores. For example, trustworthiness/reputation service categories may be considered less important than indicators of presence of malware. An indication that the asset is/was a phishing target may be weighted more heavily than the trustworthiness rating. The final score computed as a weighted sum or a weighted average may be compared to a specified summary threshold to determine whether to designate the asset as one that has fallen into a state of disrepair. An assert determined to be in a state of disrepair may be terminated (e.g., shut down, isolated from a network, etc.), may be examined further, and may be repaired.

In some embodiments, depending on the types and values of the obtained/computed individual scores and/or types of individual flags that are set to TRUE or FALSE values, the owner entity may take different kinds of actions. For example, if the trustworthiness flag is set to a TRUE value, indicating a low trustworthiness score/rating, the asset, i.e., the corresponding domain/subdomain and associated web servers and web services, etc., may be shut down. If the presence of malware score is high, further web server analysis may be performed to detect and eliminate the malware.

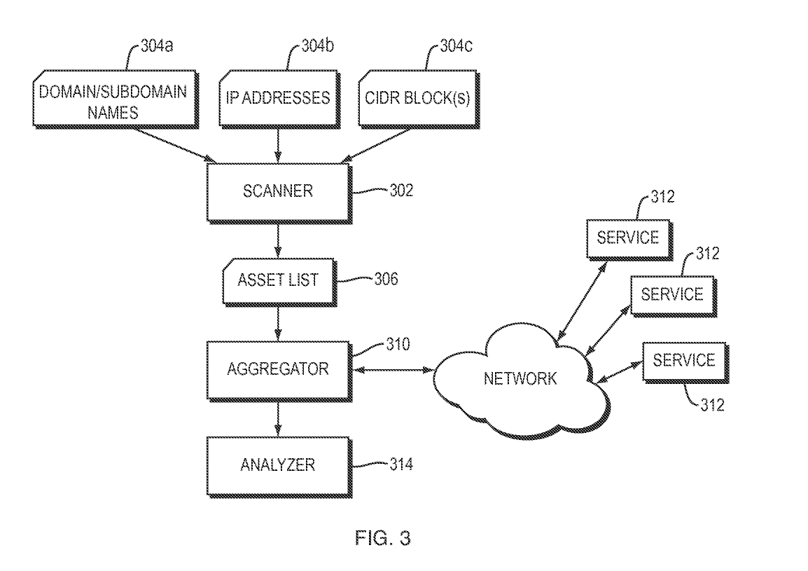

In some situations, an entity may not be aware of all of the web properties that are owned by the entity and for which the entity may be liable. In these situations, with reference to FIG. 3, a scanner 302 can receive information such as domain names and/or subdomain names 304a that are known to be owned by the entity, Internet protocol (IP) addresses 304b that are associated with the entity, and/or classless inter-domain routing (CIDR) blocks 304c associated with the entity. Using this information, the scanner 302 can generate a list of assets 306 (e.g., domain and subdomain names) owned by the entity. To this end, the scanner 302 may employ one or more of: port scanning, which can include transmission control protocol (TCP) scanning, protocol scanning, etc.; idle scanning; domain name search (DNS) lookup, which may include one or more of standard DNS queries, zone transfer queries, and reverse DNS lookups; search using APIs provided by search engines; and subdomain brute-forcing on domain names, to identify web properties that may be owned by the entity.

The scanner 302 may also employ filtering to control the web properties discovered and/or to identify, in particular, web properties that are web servers. The domain/subdomain names corresponding to the identified web servers may be the assets owned by the entity for which it may be liable. An aggregator 310 may determine which of these asset(s) are in a state of disrepair and which ones are not. To this end, the aggregator 310 may apply either or both procedures described above with reference to FIGS. 2 and 3 to each identified asset. The aggregator 310 may request and receive, through a network, scores, ratings, confidence levels, etc., from one or more services/service providers 312 such as WOT, GSB, PhishTank, etc.

In some embodiments, one or more of the assets that are determined to be in a state of disrepair are shut down and/or may be repaired. The assets that are not determined to be in a state of disrepair may be analyzed further by an analyzer 314 to identify any vulnerabilities therein. In this way, the number of assets to be subjected to analysis, e.g., vulnerability analysis, can be controlled so as to improve speed and/or efficiency of such analyses. One or more processors, servers, etc., can implement the scanner 302, the aggregator 310, and the analyzer 314.

It is clear that there are many ways to configure the device and/or system components, interfaces, communication links, and methods described herein. The disclosed methods, devices, and systems can be deployed on convenient processor platforms, including network servers, personal and portable computers, and/or other processing platforms. Other platforms can be contemplated as processing capabilities improve, including personal digital assistants, computerized watches, cellular phones and/or other portable devices. The disclosed methods and systems can be integrated with known network management systems and methods. The disclosed methods and systems can operate as an SNMP agent, and can be configured with the IP address of a remote machine running a conformant management platform. Therefore, the scope of the disclosed methods and systems are not limited by the examples given herein, but can include the full scope of the claims and their legal equivalents.

The methods, devices, and systems described herein are not limited to a particular hardware or software configuration, and may find applicability in many computing or processing environments. The methods, devices, and systems can be implemented in hardware or software, or a combination of hardware and software. The methods, devices, and systems can be implemented in one or more computer programs, where a computer program can be understood to include one or more processor executable instructions. The computer program(s) can execute on one or more programmable processing elements or machines, and can be stored on one or more storage medium readable by the processor (including volatile and non-volatile memory and/or storage elements), one or more input devices, and/or one or more output devices. The processing elements/machines thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processing element as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) and/or processing elements can thus be embedded in one or more devices that can be operated independently or together in a networked environment, where the network can include, for example, a Local Area Network (LAN), wide area network (WAN), and/or can include an intranet and/or the Internet and/or another network. The network(s) can be wired or wireless or a combination thereof and can use one or more communications protocols to facilitate communications between the different processors/processing elements. The processors can be configured for distributed processing and can utilize, in some embodiments, a client-server model as needed. Accordingly, the methods, devices, and systems can utilize multiple processors and/or processor devices, and the processor/processing element instructions can be divided amongst such single or multiple processor/devices/processing elements.

The device(s) or computer systems that integrate with the processor(s)/processing element(s) can include, for example, a personal computer(s), workstation (e.g., Dell, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor”, or “a processing element,” “the processor,” and “the processing element” can be understood to include one or more microprocessors that can communicate in a stand-alone and/or a distributed environment(s), and can thus can be configured to communicate via wired or wireless communications with other processors, where such one or more processor can be configured to operate on one or more processor/processing elements-controlled devices that can be similar or different devices. Use of such “microprocessor,” “processor,” or “processing element” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. For example, the memory can be a flash drive, a computer disc, CD/DVD, distributed memory, etc. References to structures include links, queues, graphs, trees, and such structures are provided for illustration and not limitation. References herein to instructions or executable instructions, in accordance with the above, can be understood to include programmable hardware.

Although the methods and systems have been described relative to specific embodiments thereof, they are not so limited. As such, many modifications and variations may become apparent in light of the above teachings. Many additional changes in the details, materials, and arrangement of parts, herein described and illustrated, can be made by those skilled in the art. Accordingly, it will be understood that the methods, devices, and systems provided herein are not to be limited to the embodiments disclosed herein, can include practices otherwise than specifically described, and are to be interpreted as broadly as allowed under the law.

Accordingly, we claim:

1. A method for determining whether an asset of an entity is affected, the method comprising performing by a processor the steps of:
querying from one or more quality-assessment services, respective quality scores for an asset, the asset comprising at least one of a domain name and subdomain name, via a query comprising a one or more types of scores that are requested;
aggregating the one or more quality scores to obtain an aggregate score for the asset; and
determining whether the asset is associated with content designated harmful, based on, at least in part, the aggregate score for the asset.

2. (canceled)

3. The method of claim 1, wherein querying a quality score from a quality-assessment service comprises transmitting through a network an asset identifier to a server providing the quality-assessment service.

4. The method of claim 1, wherein:
at least one of the one or more quality-assessment services comprises a WOT service; and
a respective quality score received from the WOT service comprises at least one of: (i) a reputation score, (ii) a child safety rating score, and (iii) a category score corresponding to a specified category.

5. The method of claim 4, wherein a specified category is selected from a group consisting of BAD, ADULT, and a WOT-defined category.

6. The method of claim 1, wherein:
at least one of the one or more quality-assessment services comprises a GSB service; and
a respective quality score received from the GSB service represents at least one of: (i) a likelihood of presence of malware at the asset, and (ii) a likelihood that the asset comprises a phishing offender.

7. The method of claim 1, wherein:
at least one of the one or more quality-assessment services comprises a phishing repository report service; and
a respective quality score received from the phishing repository report service represents at least one of: (i) a likelihood that the asset comprises a phishing offender, and (ii) a likelihood that the asset was a target of a phishing attack.

8. The method of claim 1, wherein:
one of the one or more quality-assessment services comprises a domain registry risk assessment service; and
a respective quality score received from the domain registry risk assessment service represents a similarity between an identifier of the asset and a domain name.

9. The method of claim 1, wherein:
aggregating the one or more quality scores comprises:
(i) designating a Boolean value to each quality score based on a respective threshold; and
(ii) computing a logical OR of the respective Boolean values; and
determining whether the asset is affected comprises designating the asset as affected if the logical OR is TRUE.

10. The method of claim 1, wherein:
aggregating the one or more quality scores comprises computing a weighted average of the one or more quality scores based on respective scaling factors; and
determining whether the asset is affected comprises designating the asset as affected if the weighted average is at least equal to a specified threshold.

11. The method of claim 1, further comprising:
receiving, in a memory, a list of resources;
scanning, using a scanner, each resource in the list, to obtain a list of assets associated with an entity; and
repeating the querying, aggregating, and designating steps for each asset in the list of assets, to identify any affected assets associated with the entity.

12. The method of claim 11, wherein a resource in the list of resources comprises one of a domain name, an Internet protocol (IP) address, and a CIDR block.

13. The method of claim 11, wherein scanning comprises at least one of: port scanning, idle scanning, domain name service (DNS) lookup, and subdomain brute-forcing.

14. The method of claim 11, further comprising performing vulnerability analysis for one or more assets in the list of assets that are not designated as affected assets.

15. A system for determining whether an asset of an entity is affected, the system comprising:
a first processor; and
a first memory in electrical communication with the first processor, the first memory comprising instructions which, when executed by a processing unit comprising at least one of the first processor and a second processor, and in electronic communication with a memory module comprising at least one of the first memory and a second memory, program the processing unit to:
(a) query from one or more quality-assessment services, respective quality scores for an asset the asset comprising at least one of a domain name and subdomain name, and the query comprising a one or more types of scores that are requested;
(b) aggregate the one or more quality scores to obtain an aggregate score for the asset; and
(c) determine whether the asset is associated with content designated harmful, based on, at least in part, the aggregate score for the asset.

16. (canceled)

17. The system of claim 15, wherein to query a quality score from a quality-assessment service, the processing unit is programmed to transmit through a network an asset identifier to a server providing the quality-assessment service.

18. The system of claim 15, wherein:
at least one of the one or more quality-assessment services comprises a WOT service; and
a respective quality score received from the WOT service comprises at least one of: (i) a reputation score, (ii) a child safety rating score, and (iii) a category score corresponding to a specified category.

19. The system of claim 18, wherein a specified category is selected from a group consisting of BAD, ADULT, and a WOT-defined category.

20. The system of claim 15, wherein:
at least one of the one or more quality-assessment services comprises a GSB service; and
a respective quality score received from the GSB service represents at least one of: (i) a likelihood of presence of malware at the asset, and (ii) a likelihood that the asset comprises a phishing offender.

21. The system of claim 15, wherein:
at least one of the one or more quality-assessment services comprises a phishing repository report service; and
a respective quality score received from the phishing repository report service represents at least one of: (i) a likelihood that the asset comprises a phishing offender, and (ii) a likelihood that the asset was a target of a phishing attack.

22. The system of claim 15, wherein:
one of the one or more quality-assessment services comprises a domain registry risk assessment service; and
a respective quality score received from the domain registry risk assessment service represents a similarity between an identifier of the asset and a domain name.

23. The system of claim 15, wherein:
to aggregate the one or more quality scores, the processing unit is programmed to:
(i) designate a Boolean value to each quality score based on a respective threshold; and
(ii) compute a logical OR of the respective Boolean values; and
to determine whether the asset is affected the processing unit is programmed to designate the asset as affected if the logical OR is TRUE.

24. The system of claim 15, wherein:
to aggregate the one or more quality scores, the processing unit is programmed to compute a weighted average of the one or more quality scores based on respective scaling factors; and
to determine whether the asset is affected the processing unit is programmed to designate the asset as affected if the weighted average is at least equal to a specified threshold.

25. The system of claim 15, wherein:
the memory module is configured to receive a list of resources; and
the processing unit is further programmed to:
scan each resource in the list, to obtain a list of assets associated with an entity; and
repeat operations (a), (b), and (c) for each asset in the list of assets, to identify any affected assets associated with the entity.

26. The system of claim 25, wherein a resource in the list of resources comprises one of a domain name, an Internet protocol (IP) address, and a CIDR block.

27. The system of claim 25, wherein to scan each resource in the list, the processing unit is programmed to perform at least one of: port scanning, idle scanning, domain name service (DNS) lookup, and subdomain brute-forcing.

28. The system of claim 25, wherein the processing unit is further programmed to perform vulnerability analysis for one or more assets in the list of assets that are not designated as affected assets.

29. An article of manufacture that includes a non-transitory storage medium has stored therein instructions which, when executed by a processing unit in electronic communication with a memory module, program the processing unit, for determining whether an asset of an entity is affected, to:
(a) query from one or more quality-assessment services, respective quality scores for an asset, the asset comprising at least one of a domain name and subdomain name, and the query comprising a one or more types of scores that are requested;
(b) aggregate the one or more quality scores to obtain an aggregate score for the asset; and
(c) determine whether the asset is associated with content designated harmful, based on, at least in part, the aggregate score for the asset.
